(19) United States
(12) Patent Application Publication
(10) Pub. No.: US 2026/0237008 A1
(43) Pub. Date: Aug. 13, 2026

(54) SYSTEMS AND METHODS FOR MACHINE LEARNING ASSISTED COMPETITIVENESS ANALYSIS

(71) Applicant: Shabnam Shafiee, Mclean, VA (US)

(72) Inventor: Shabnam Shafiee, Mclean, VA (US)

(21) Appl. No.: 19/051,637

(22) Filed: Feb. 12, 2025

(51) Int. Cl. G06Q 50/163; G06Q 10/107; G06Q 50/18

(52) U.S. Cl. CPC G06Q 50/163; G06Q 10/107; G06Q 50/188

(57) ABSTRACT

A method of machine learning assisted competitiveness analysis of properties available for transfer of ownership by one or more processors of one or more computing devices, comprising receiving data comprising at least: an asking value of each property, parameters indicative of an assessed value of each property, and parameters indicative of a measure of similarity among the properties; feeding the data into at least one trained machine learning model to generate a measure of relative negotiability of the asking value of the properties as compared to each other; determining, based on the measure of relative negotiability, whether the asking value of a first subset of the properties is more negotiable than the asking value of a second subset of properties; and generating an indication of the asking value of the first subset of properties being more negotiable than the asking value of the second subset of properties.

### FIELD

The present aspects are directed at systems and methods for machine learning assisted competitiveness analysis.

### BRIEF DESCRIPTION OF THE DRAWINGS

The accompanying drawings, which form a part of this specification, illustrate various aspects of the disclosure and, together with the description, serve to explain the principles of the disclosure. In the drawings, like reference numerals refer to like elements throughout the drawings. The drawings are not necessarily to scale, and certain features may be exaggerated or simplified for clarity. The drawings are intended to illustrate the present aspects and should not be construed to limit the scope of the present aspects.

FIG. 1 is a block diagram of a system for machine learning assisted competitiveness analysis, according to some aspects of the present disclosure.

FIG. 2 is a flowchart of an example method for machine learning assisted competitiveness analysis, according to some aspects of the present disclosure.

FIG. 3 is a block diagram of an example machine learning ensemble configured for competitiveness analysis, according to some aspects of the present disclosure.

### DETAILED DESCRIPTION

The present disclosure relates to systems and methods for machine learning assisted competitiveness analysis. The following detailed description is provided to illustrate some example aspects of the present disclosure and should not be construed to limit the scope of the present disclosure. The detailed description will be better understood in conjunction with the accompanying drawings, which form a part of this specification and illustrate by way of example the principles of the present aspects.

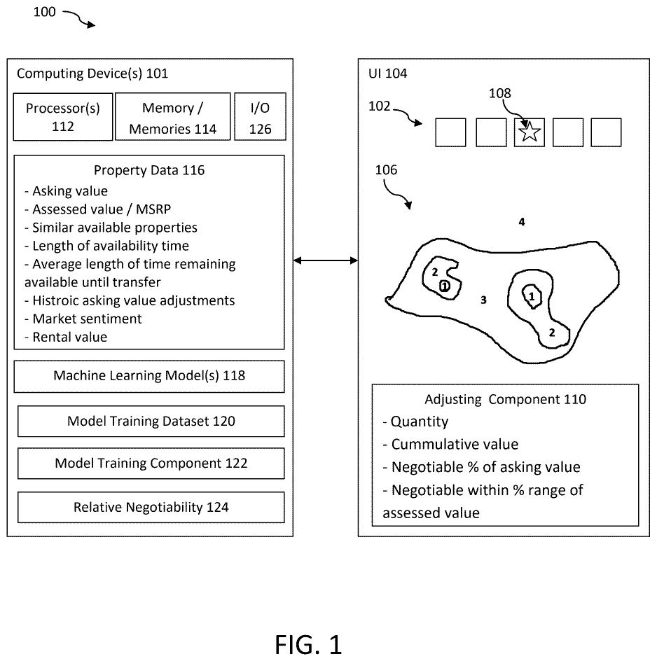

Referring to FIG. 1, a system 100 according to one non-limiting example aspect of the present disclosure receives data 116 pertaining to a plurality of properties 102 that are available for transfer of ownership, and generates an indication indicating whether a first subset of the properties 102 are more negotiable than a second subset of the properties 102. In one non-limiting example aspect, the properties 102 may be real estate properties that are available for transfer of ownership. However, the present aspects are not so limited, and in an alternative non-limited example aspect, the properties 102 may be vehicles that are available for transfer of ownership.

In one example aspect, the system 100 may initially generate and display, on a user interface 104, a heat map 106 of a geographic area of the properties 102, where the heat map 106 indicates which areas have a higher concentration of the properties 102 that are available for transfer of ownership. For example, in an aspect, the heat map 106 may display a warmer color for geographic areas that have a higher quantitative concentration of the properties 102 available for transfer of ownership. For example, in a real estate scenario, a red color may be used in the heat map 106 for areas “1” having more that 10 properties on sale per acre, an orange color is used in the heat map 106 for areas “2” having between 5 to 9 properties on sale per acre, a yellow color is used in the heat map 106 for areas “3” having between 1 to 4 properties on sale per acre, and a gray color is used in the heat map 106 for areas “4” having no properties on sale per acre.

In an aspect, the heat map 106 may then be adjustable to use warmer colors based on other attributes of the properties 102 available for transfer of ownership. For example, instead of using warmer colors for geographic areas that have a higher quantitative concentration of the properties 102 available for transfer of ownership, the heat map 106 may be adjusted to use warmer colors for geographic areas that have a higher cumulative value of the properties 102 available for transfer of ownership. For example, in a real estate scenario, a red color may be used in the heat map 106 for areas having properties on sale with a combined value of more than 10 million dollars per acre, while an orange color is used in the heat map 106 for areas having properties on sale with a combined value of between 5 to 9 million dollars per acre, etc.

In yet another aspect, the heat map 106 may alternatively or additionally be adjustable to use warmer colors for areas in which the properties 102 available for transfer of ownership are more negotiable. For example, in a real estate scenario, a red color may be used in the heat map 106 for areas having properties on sale that are negotiable by 10% or more of their asking value, while an orange color is used in the heat map 106 for areas having properties on sale that are negotiable by between 5% to 10% of their asking value, etc. The negotiability percentage of a property may be determined using any of the various aspects described herein below.

In some aspects, instead of or in addition to the heat map 106, the system 100 may display a marker 108 for a property 102, where a color, shape, or other visual attribute of the marker 108 indicates an estimate amount of negotiability of that property 102. For example, in a real estate scenario, a red marker may be displayed next to or on an available property that is negotiable by 10% or more of the asking value, while an orange marker is displayed next to or on a property on sale that is negotiable by between 5% to 10% of the asking value, etc.

In yet another aspect, the heat map 106 may be alternatively or additionally adjustable to use warmer colors for areas in which the properties 102 available for transfer of ownership are negotiable down to a certain range of their assessed value. For example, in a real estate scenario, a red color may be used in the heat map 106 for areas having properties on sale that are negotiable down to a 2% range of their assessed value, while an orange color is used in the heat map 106 for areas having properties on sale that are negotiable down to a 2% to 5% range of their assessed value, etc. The negotiability of a property down to a certain range of its assessed value may be determined using any of the various aspects described herein below.

In some aspects, instead of or in addition to the heat map 106, the system 100 may display the marker 108 for each property 102, where a color, shape, or other visual attribute of the marker 108 indicates that the property 102 is negotiable down to a certain range of its assessed value. For example, in a real estate scenario, a red marker may be displayed next to or on an available property that is negotiable down to a 2% range of its assessed value, while an orange marker is displayed next to or on a property on sale that is negotiable down to a 2% to 5% range of its assessed value, etc.

In some aspects, the system 100 may provide and display one or more adjusting features that allow for adjusting the display of the heat map 106 and/or the markers 108. Specifically, for example, the system 100 may provide, on the user interface 104, an adjusting component 114 that allows for adjusting the heat map 106 and/or the markers 108 to indicate which areas have a higher quantitative concentration of the available properties, or which areas have a higher cumulative value of the available properties, or which areas have a higher concentration of available properties that are more negotiable, or which areas have higher concentration of available properties that are negotiable down to a certain range of their assessed value.

In an aspect, the system 100 may estimate a percentage amount of negotiability of an available property 102 based on factors such as: an asking value of the property 102, an assessed value of the property 102, a quantity of other similar properties that are available, an amount of time that the property 102 and/or other similar properties 102 have been available, an average amount of time in a recent period that similar properties have remained available before being transferred, if and/or when and/or how much and/or how many times the asking value of the property has been adjusted (e.g., reduced), past and/or current and/or future market sentiments of potential parties interested in acquiring the property 102, past and/or current and/or future rental market value of the property 102 or similar properties, etc.

For example, in one non-limiting example aspect, when the asking value of an available property 102 is above its assessed value, the system 100 may generate an initial estimate P of the percentage amount of negotiability of the property 102 to be:

P=(asking value-assessed value)×100/asking value

The system 100 may then adjust P based on one or more parameters such as a quantity of other similar properties that are available, an amount of time that the property 102 and/or other similar properties 102 have been available, an average amount of time in a recent period that similar properties have remained available before being transferred, if and/or when and/or how much and/or how many times the asking value of the property has been adjusted (e.g., reduced), past and/or current and/or future market sentiments of potential parties interested in acquiring the property 102, past and/or current and/or future rental market value of the property 102 or similar properties, etc.

For example, the system 100 may use a function that increases P when a quantity of other similar properties that are available increases, and/or when an amount of time that the property 102 and/or other similar properties 102 have been available increases, and/or when an average amount of time in a recent period that similar properties have remained available before being transferred increases, and/or when the asking value of the property is lowered, and/or when a market sentiment of potential parties interested in acquiring the property 102 deteriorates, and/or when a rental market value of the property 102 decreases, etc.

For example, in a real estate scenario, the system 100 may increase P by a certain amount (e.g., 1%) every time a new similar property becomes available in a certain radius, and/or when the amount of time that the property 102 and/or other similar properties 102 have been available passes a threshold (e.g., the properties remained available for an extra month), and/or when an average amount of time in a recent period that similar properties have remained available before being transferred passes a threshold (e.g., the properties that were transferred in the immediate past 6 months remained available for an extra month), and/or when the asking value of the property is lowered (showing seller motivation), and/or when a market sentiment of potential parties interested in acquiring the property 102 deteriorates (e.g., based on social media data or other market indicators), and/or when the number of similar properties available for rent increases by a certain amount.

It should be noted that each of the above parameters may affect how the other parameters change P. For example, a property may not become more negotiable when it remains available for an extra month but there are no other new similar properties becoming available, but the property may become more negotiable when it remains available for an extra month and there is also a new similar property that has become available during that month. A current value of P may also affect how the other parameters change P. For example, a property may not become more negotiable when it remains available for an extra month and the current value of P is 20%, but it may become more negotiable when it remains available for an extra month and the current value of P is 0%. Accordingly, some present aspects determine and/or adjust P using an integrated analysis of any combination of the available and/or relevant parameters described herein.

For example, in an aspect, the system 100 may use one or more trained machine learning models 118 to determine and/or adjust an amount of negotiability of each property 102 that is available for transfer of ownership. For example, the machine learning models 118 may be trained to estimate and/or adjust a percentage amount of negotiability of an available property 102 based on factors such as: a quantity of other similar properties that are available, an amount of time that the property 102 and/or other similar properties 102 have been available, an average amount of time in a recent period that similar properties have remained available before being transferred, if and/or when and/or how much and/or how many times the asking value of the property has been adjusted (e.g., reduced), past and/or current and/or future market sentiment of potential parties interested in acquiring the property 102, past and/or current and/or future rental market value of the property 102 or other similar properties, etc.

In an aspect, the system 100 may implement the machine learning models 118 using a combination of hardware and software components configured to perform tasks using machine learning techniques. For example, the system 100 may include one or more computing devices 101, such as one or more servers, cloud computing resources/platform, or other electronic devices capable of executing machine learning algorithms, individually or in combination. For example, the computing devices 101 may include one or more processors 112 and one or memories 114, where the one or more processors 112, individually or in combination, are configured to execute instructions stored on the one or more memories 114 to perform tasks using machine learning techniques as described herein.

In some aspects, the computing device 101 may execute a model training component 122 to train the machine learning models 112 on a model training dataset 120 to learn patterns and relationships within data. The machine learning models 112 may be trained using supervised, unsupervised, or semi-supervised learning techniques, depending on the nature of the data and the task at hand. The machine learning models 112 may include, but are not limited to, neural networks, decision trees, support vector machines, or other types of machine learning models.

In some aspects, the system 100 may receive property data 116 from various sources, such as publicly available online information, databases (either internal or external to the computing device 101), data lakes (e.g., accessible via a cloud system), user interfaces, etc., and process this data 116 using the trained machine learning models 112 to generate predictions, classifications, or other outputs, such as relative negotiability 124 of each property 102, any of the heat maps 106, etc. The system 100 may also include feedback mechanisms to refine the machine learning models 112 over time based on new data or performance metrics.

In various aspects, the system 100 may be implemented using a variety of frameworks and tools, such as TensorFlow, PyTorch, or scikit-learn, and may be deployed in a cloud-based environment, on-premises, or in a hybrid configuration.

In some aspects, the machine learning models 112 may be trained using the model training dataset 120 that includes a plurality of data samples. Each data sample may comprise input features and corresponding output labels or targets. The input features may include, for example, a plurality of properties, and for each property, its asking value, assessed value, a quantity of other similar properties that are available, an amount of time that the property and/or other similar properties have been available, an average amount of time in a recent period that similar properties have remained available before being transferred, if and/or when and/or how much and/or how many times the asking value of the property has been adjusted (e.g., reduced), past and/or current and/or future market sentiments of potential parties interested in acquiring the property, past and/or current and/or future rental market value of each property or other similar properties, etc. The labeled outputs may include, for each property, an accurate negotiability percentage estimate of the property, and one or more inaccurate negotiability percentage estimates of the property. The training dataset 120 may be collected from various sources, such as publicly available online information, databases, or user interactions, and may undergo preprocessing steps to ensure quality and consistency.

To train a model, the training dataset 120 is typically split into training and validation sets. The training set is used to update the model's parameters to minimize a loss function, which measures the difference between the model's predictions and the actual outputs. The validation set is used to evaluate the model's performance during training and prevent overfitting.

The training process may involve the following steps: (1) Initialization, (2) Forward Pass, (3) Loss Calculation, (4) Backward Pass, (5) Parameter Update, and (6) Iteration. During Initialization, the model's parameters are initialized with random or predefined values. During Forward Pass, the input features are propagated through the model to generate predictions. During Loss Calculation, the loss between the predictions and actual outputs is calculated using a loss function, such as mean squared error or cross-entropy. During Backward Pass, the gradients of the loss with respect to the model's parameters are computed. During Parameter Update, the model's parameters are updated using an optimization algorithm, such as stochastic gradient descent (SGD), Adam, or RMSProp, based on the gradients and a learning rate. During Iteration, steps (2)-(5) are repeated for multiple iterations until convergence or a stopping criterion is reached.

The trained model is then evaluated on a test set to assess its performance and accuracy, e.g., by providing a new set of inputs (a new property and its parameters) into the model and evaluating an output of the model (whether a negotiability percentage estimate of the property as output by the model is accurate). The model may be fine-tuned by adjusting hyperparameters, such as the learning rate, batch size, or number of layers, to improve its performance.

In one non-limiting example aspect, the machine learning models 112 may include a regression model that utilizes machine learning techniques to predict a negotiability percentage value of a property 102 based on multiple input factors, such as but not limited to an asking value of the property 102, an assessed value of the property 102, a quantity of other similar properties that are available, an amount of time that the property 102 and/or other similar properties 102 have been available, an average amount of time in a recent period that similar properties have remained available before being transferred, if and/or when and/or how much and/or how many times the asking value of the property has been adjusted (e.g., reduced), past and/or current and/or future market sentiments of potential parties interested in acquiring the property 102, past and/or current and/or future rental market value of the property 102 or other similar properties, etc.

In some aspects, instead of or in addition to the assessed value of the property 102, one or more parameters that affect the assessed value of the property 102 may also be directly used by the machine learning models 112 to predict the negotiability percentage value of a property 102. For example, in a real estate scenario, instead of or in addition to one or more of the above-noted parameters, the machine learning models 112 may further consider various parameters that affect an assessed value of a property such as property characteristics (e.g., size in square meters), number of bedrooms and bathrooms, age of the property, condition (e.g., new, renovated, etc.), location factors (e.g., proximity to amenities such as schools, parks, an shopping centers, neighborhood quality, accessibility to public transport, etc.), market trends (e.g., recent sales data in the area, average value per square meter, market demand indicators (e.g., rental yields), etc.), economic indicators (e.g., local unemployment rates, GDP growth rate, interest rates, etc.), etc.

Similarly, in some aspects, instead of or in addition to a market sentiment of potential parties interested in acquiring the property 102, one or more parameters that affect the market sentiment of potential parties interested in acquiring the property 102 may also be directly used by the machine learning models 112 to predict a negotiability percentage value of the property 102. For example, in a real estate scenario, instead of or in addition to one or more of the above-noted parameters, the models 112 may further consider various parameters that affect the market sentiment of potential parties interested in acquiring real estate, such as seasonal factors (e.g., school year being less desirable), interest rates (e.g., higher interest rates being discouraging), stock market fluctuations (e.g., a market downturn causing a shift from a greed sentiment to a fear sentiment), global fears (e.g., climate disasters, war, political conflicts, etc. causing a shift from a greed sentiment to a fear sentiment), etc.

In some aspects, the model architecture may include data preprocessing configured to normalize or scale numerical data and encode categorical data using techniques such as one-hot encoding. Feature engineering may also be used to extract relevant features from raw data, such as calculating the average value per square meter in a neighborhood.

In some aspects, the machine learning models 112 may include one or more or any combination of Linear Regression (suitable for linear relationships between inputs and outputs), Random Forest Regressor (effective for handling complex, nonlinear relationships and feature interactions), Neural Networks (can learn intricate patterns in data, especially useful with large datasets), and Large Language Models (e.g., for determining consumer sentiment based on analysis of social media content, etc.). In some aspects, for model training and evaluation, the model training dataset 120 is split into training and testing sets. The machine learning models 118 are trained on the training set, and their performance is evaluated on the test set using metrics such as Mean Absolute Error (MAE) or Mean Squared Error (MSE). Hyperparameter tuning may also be implemented using techniques such as Grid Search or Cross-Validation to optimize model parameters for better performance.

In some aspects, the trained machine learning models 118 output a predicted relative negotiability 124 indicating how negotiable a property is. For example, in one non-limiting aspect, the trained machine learning models 118 may output an estimated discount in the asking value that is achievable for a specific property, which can be used to determine whether the property is negotiable down to a certain range of its assessed value. For example, if a property is listed at $100K, and its assessed value is $90K, and is 5% negotiable, then the property is negotiable down to a 5% range of its assessed value.

A non-limiting simplified example code for using a Random Forest Regressor in Python to output p a predicted relative negotiability 124 is as follows:
import pandas as pd
from sklearn.ensemble import RandomForestRegressor
from sklearn.model_selection import train_test_split
from sklearn.metrics import mean_squared_error
#Load data
df=pd.read_csv(‘property_data.csv’)
#Preprocess data
X=df.drop([‘target_percentage’], axis=1) #Features
y=df[‘target_percentage’] #Target variable
#Split data into training and testing sets
X_train, X_test, y_train, y_test=train_test_split(X, y, test_size=0.2, random_state=42)
#Initialize and train the model
model=RandomForestRegressor(n_estimators=100, random_state=42)
model.fit(X_train, y_train)
#Make predictions and evaluate the model
y_pred=model.predict(X_test)
mse=mean_squared_error(y_test, y_pred)
print(f′Mean Squared Error: {mse}′)
#Use the model to predict a new property's predicted relative negotiability
new_property=pd.DataFrame({
‘size’: [100],
‘bedrooms’: [3],
‘location_score’: [8],
#Add other relevant features here
})
predicted_percentage=model.predict(new_property)
print(f′Predicted relative negotiability: {predicted_percentage[0]}′)

This model can be refined further by incorporating additional factors, using more advanced machine learning techniques, or integrating with other data sources such as news networks, satellite imagery, social media activity, the stock exchanges, a multiple listing service (MLS for real estate properties), auto dealership or automaker websites (for vehicles), etc.

In some aspects, one or more of the machine learning models 118 may also be trained to generate any of the heat maps 106 described herein. For example, the machine learning models 118 may include Convolutional Neural Networks (CNNs) which are effective for spatial data, such as a geographic heat maps. They can learn spatial relationships and patterns in the data.

The present aspects may be implemented using one or more computing devices 101, such as one or more computers, servers, or other electronic devices capable of executing instructions. The computing devices 101 may include one or more processors 112, one or more memories 114, and input/output interfaces 126. The one or more processors 112 may include a central processing unit (CPU), a graphics processing unit (GPU), or any other type of processing unit capable of executing instructions. The one or more memories 114 may include volatile memory, non-volatile memory, or a combination thereof. The one or more memories 114 may, individually or in combination, store data and instructions for execution by the one or more processors 112, individually or in combination.

The input/output interfaces 126 may include a display, keyboard, mouse, network interface, or other devices for interacting with the computing devices 101. The computing devices 101 may be connected to a network, such as the Internet, a local area network (LAN), or a wide area network (WAN), to communicate with other devices or access remote resources.

The computing devices 101 may execute software instructions stored in the one or more memories 114 to perform various functions, including data processing, communication, and control. The software instructions may be written in any programming language and may be executed by the one or more processors 112, individually or in combination, to implement any one or any combination or any portion of the methods and systems described herein.

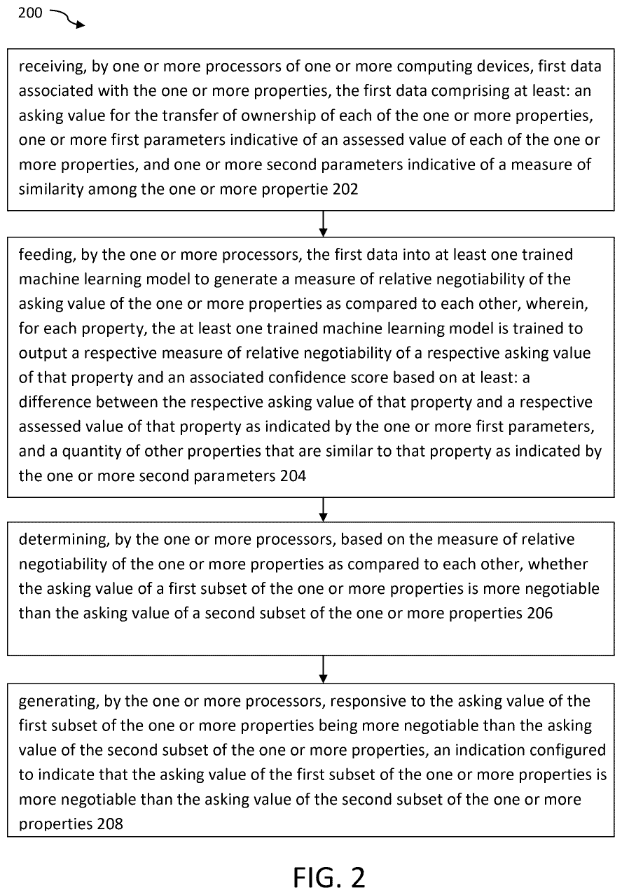

Referring to FIG. 2, a flowchart 200 of an example method of machine learning assisted competitiveness analysis of one or more properties available for transfer of ownership is provided, according to some non-limiting aspects of the present disclosure. In some aspects, the computing device(s) 101 may perform the method 200 such as via execution of the machine learning models 118 by the one or more processors 112, individually or in combination, and/or the one or more memories 114, individually or in combination. Specifically, the computing device(s) 101 may be configured to perform the method 200 of machine learning assisted competitiveness analysis of one or more properties available for transfer of ownership, as described herein.

At block 202, the method 200 includes receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties. For example, in an aspect, the computing device(s) 101, the one or more processors 112 individually or in combination, and/or the one or more memories 114 individually or in combination may be configured to or may comprise means for receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties.

For example, the computing device(s) may receive the property data 116 associated with one or more properties 102, where the property data 116 includes at least: an asking value for the transfer of ownership of each of the one or more properties 102, one or more first parameters indicative of an assessed value of each of the one or more properties 102, and one or more second parameters indicative of a measure of similarity among the one or more properties 102.

At block 204, the method 200 includes feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters. For example, in an aspect, the computing device(s) 101, the one or more processors 112 individually or in combination, and/or the one or more memories 114 individually or in combination may be configured to or may comprise means for feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters.

For example, the computing device(s) 101 may feed the property data 116 into at least one trained machine learning model 118 to generate a measure of relative negotiability 124 of the asking value of the one or more properties 102 as compared to each other, wherein, for each property, the at least one trained machine learning model 118 is trained to output a respective measure of relative negotiability 124 of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters.

At block 206, the method 200 includes determining, by the one or more processors, based on the measure of relative negotiability of the one or more properties as compared to each other, whether the asking value of a first subset of the one or more properties is more negotiable than the asking value of a second subset of the one or more properties. For example, in an aspect, the computing device(s) 101, the one or more processors 112 individually or in combination, and/or the one or more memories 114 individually or in combination may be configured to or may comprise means for determining, by the one or more processors, based on the measure of relative negotiability of the one or more properties as compared to each other, whether the asking value of a first subset of the one or more properties is more negotiable than the asking value of a second subset of the one or more properties.

For example, the computing device(s) 101 may determine, based on the measure of relative negotiability 124 of the one or more properties 102 as compared to each other, whether the asking value of a first subset of the one or more properties is more negotiable than the asking value of a second subset of the one or more properties.

At block 208, the method 200 includes generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties. For example, in an aspect, the computing device(s) 101, the one or more processors 112 individually or in combination, and/or the one or more memories 114 individually or in combination may be configured to or may comprise means for generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

For example, the computing device(s) 101 may generate, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

In some example implementations, the measure of relative negotiability 124 of the one or more properties 102 as compared to each other is based on estimated negotiability percentages of the asking value of each of the one or more properties 102.

In some example implementations, generating the indication comprises providing, on a user interface 104 of one or more computing devices, responsive to the asking value of the first subset of the one or more properties being more negotiable than the asking value of the second subset of the one or more properties, a graphical representation of the first measure of relative negotiability of the one or more properties, wherein the graphical representation is configured to indicate that the asking value of the first subset of the one or more properties is more negotiable than the asking value of the second subset of the one or more properties.

In some example implementations, the graphical representation comprises a heat map 106 configured to indicate that the asking value of the first subset of the one or more properties is more negotiable than the asking value of the second subset of the one or more properties.

In some example implementations, generating the indication comprises sending, by the one or more computing devices 101, responsive to the asking value of the first subset of the one or more properties being more negotiable than the asking value of the second subset of the one or more properties, a message configured to indicate that the asking value of the first subset of the one or more properties is more negotiable than the asking value of the second subset of the one or more properties.

In some example implementations, sending the message comprises pushing the message into a user device of a user and/or sending the message to an email address of the user.

In some example implementations, the one or more properties 102 comprise one or more real estate properties, wherein the first data comprises at least: the asking value for the transfer of ownership of each of the one or more real estate properties, the one or more first parameters indicative of the assessed value of each of the one or more real estate properties, and one or more second parameters indicative of the measure of similarity among the one or more properties including at least a geographical location of each of the one or more real estate properties.

In some example implementations, for each real estate property, the first data further comprises a quantity of other similar real estate properties that are available, an amount of time that real estate property and/or similar real estate properties have been available, an average amount of time in a recent period that similar transferred real estate properties have remained available before being transferred, if and/or when and/or how much and/or how many times the asking value of that real estate property has been adjusted, past and/or current and/or future market sentiment of potential parties interested in acquiring that real estate property, past and/or current and/or future rental market value of that real estate property and/or other similar real estate properties.

In some example implementations, the one or more properties 102 comprise one or more vehicles, wherein the first data comprises at least: the asking value for the transfer of ownership of each of the one or more vehicles, the one or more first parameters indicative of the assessed value of each of the one or more vehicles based at least on their MSRP, and the one or more second parameters indicative of the measure of similarity among the one or more vehicles including model, year, mileage, color, and transmission type of the one or more vehicles.

In some example implementations, the first data (116) comprises textual or audio data associated with the one or more properties, wherein the at least one trained machine learning model comprises a natural language processing model trained to generate the measure of relative negotiability of the asking value of the one or more properties as compared to each other at least based on analyzing the textual or audio data.

In some example implementations, the method 200 may further comprise: receiving, by the one or more processors of the one or more computing devices, updated data comprising an update to the first data; feeding, by the one or more processors of the one or more computing devices, the updated data into the at least one trained machine learning model to generate an updated measure of relative negotiability of the asking value of the one or more properties as compared to each other; determining, by the one or more processors of the one or more computing devices, based on the updated measure of relative negotiability of the asking value of the one or more properties as compared to each other, whether the asking value of a third subset of the one or more properties is more negotiable than the asking value of a fourth subset of the one or more properties; and generating, by the one or more computing devices, responsive to the asking value of the third subset of the one or more properties being more negotiable than the asking value of the fourth subset of the one or more properties, a second indication configured to indicate that the asking value of the third subset of the one or more properties is more negotiable than the asking value of the fourth subset of the one or more properties.

In some example implementations, the method 200 may further comprise: receiving second data associated with a recent transfer of ownership of a property; and updating the at least one trained machine learning model based on the second data.

In some example implementations, the method 200 may further comprise: responsive to updating the at least one trained machine learning model: feeding, by the one or more processors of the one or more computing devices, the first data and the second data into the at least one trained machine learning model to generate an updated measure of relative negotiability of the asking value of the one or more properties as compared to each other; determining, by the one or more processors of the one or more computing devices, based on the updated measure of relative negotiability of the asking value of the one or more properties as compared to each other, whether the asking value of a third subset of the one or more properties is more negotiable than the asking value of a fourth subset of the one or more properties; and generating, by the one or more computing devices, responsive to the asking value of the third subset of the one or more properties being more negotiable than the asking value of the fourth subset of the one or more properties, a second indication configured to indicate that the asking value of the third subset of the one or more properties is more negotiable than the asking value of the fourth subset of the one or more properties.

In some example implementations, the at least one trained machine learning model implements an ensemble of machine learning models. A machine learning ensemble is a technique that combines multiple individual models, called base learners/models, to improve predictive performance compared to using a single model. A machine learning ensemble uses a group of diverse models to produce more accurate and robust predictions by leveraging their collective strengths and mitigating individual weaknesses. Ensemble learning has the ability to enhance performance across various tasks, including classification, regression, and anomaly detection.

Machine learning ensembles are built based on a variety of techniques such as Bagging (or Bootstrap Aggregating, which combines predictions of homogeneous models trained on different random subsets of the data, and can reduce variance and minimizes overfitting (e.g., Random Forest)), Boosting (sequentially trains models, focusing on correcting errors made by previous models, and can reduce bias and improves accuracy (e.g., AdaBoost, Gradient Boosting)), Stacking (combines predictions from heterogeneous models, and a meta model is trained on the outputs of base models to optimize final predictions, thus can be effective when combining diverse model types), and Blending (similar to stacking but uses a holdout validation set for training the meta model instead of cross-validation).

Specifically, for example, to combine the results of different model types in an ensemble, stacking is a highly effective machine learning technique. Stacking involves training multiple diverse base models (e.g., regression models, decision trees, neural networks) independently and then combining their predictions using a meta model. The meta model learns from the outputs of the base models to make a final prediction, leveraging their strengths and compensating for individual weaknesses.

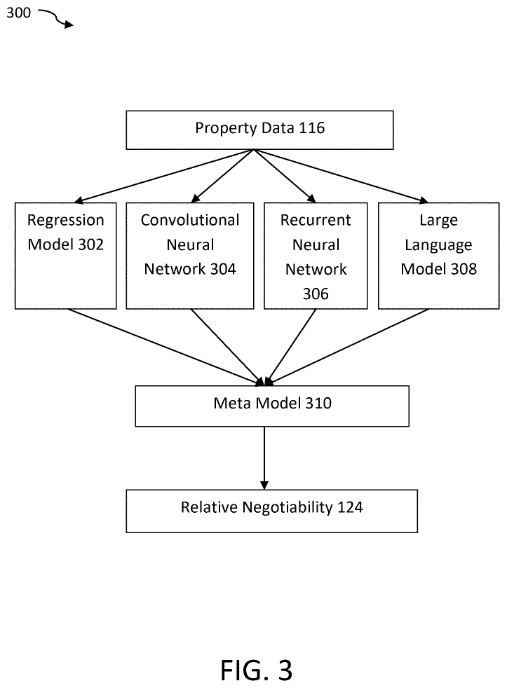

In an aspect, for example, referring to FIG. 3, an ensemble 300 of machine learning models includes a meta model 310 that aggregates outputs of a plurality of machine learning models that receive and analyze at least a portion of the property data 116. In one non-limiting example aspect, the meta model 124 may include one or more neural networks which are particularly useful when the relationships between base model predictions are complex and non-linear.

In some example implementations, the plurality of machine learning models in the ensemble 300 comprises a regression model 302 trained to analyze conventional property features in the first data 116. For example, a regression model may be used as a base learner in the ensemble of machine learning models to analyze asking conventional property features such as values, assessed values, etc.

In some example implementations, the plurality of machine learning models in the ensemble 300 comprises a convolutional neural network 304 trained to analyze sequential data in the first data 116. For example, a convolutional neural network may be used as a base learner in the ensemble of machine learning models to analyze sequential data such as an amount of time that real estate property and/or similar real estate properties have been available, an average amount of time in a recent period that similar transferred real estate properties have remained available before being transferred, if and/or when and/or how much and/or how many times the asking value of that real estate property has been adjusted, past and/or current and/or future market sentiment of potential parties interested in acquiring that real estate property, past and/or current and/or future rental market value of that real estate property and/or other similar real estate properties.

In some example implementations, the plurality of machine learning models in the ensemble 300 comprises a recurrent neural network 306 trained to analyze temporal trends in the first data 116. For example, a recurrent neural network may be used as a base learner in the ensemble of machine learning models to analyze temporal trends in such as an amount of time that real estate property and/or similar real estate properties have been available, an average amount of time in a recent period that similar transferred real estate properties have remained available before being transferred, if and/or when and/or how much and/or how many times the asking value of that real estate property has been adjusted, past and/or current and/or future market sentiment of potential parties interested in acquiring that real estate property, past and/or current and/or future rental market value of that real estate property and/or other similar real estate properties.

In some example implementations, the plurality of machine learning models in the ensemble 300 comprises a natural language processing model 308 trained to analyze textual or audio features in the first data 116. For example, a natural language processing model may be used as a base learner in the ensemble of machine learning models to analyze textual or audio data indicative of market sentiment, property desirability/review, etc. Such data may be collected, for example, from online sources and/or publicly or privately available resources.

In some example implementations, a system comprises: one or more memories storing instructions, individually or in combination; and one or more processors configured, individually or in combination, to execute the instructions to perform a method of machine learning assisted competitiveness analysis of one or more properties available for transfer of ownership, including: receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties; feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters; determining, by the one or more processors, based on the measure of relative negotiability of the one or more properties as compared to each other, whether the asking value of a first subset of the one or more properties is more negotiable than the asking value of a second subset of the one or more properties; and generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

In some example implementations, one or more non-transitory computer-readable media store instructions individually or in combination, wherein the instructions are executable by one or more processors, individually or in combination, to perform a method of machine learning assisted competitiveness analysis of one or more properties available for transfer of ownership, including: receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties; feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters; determining, by the one or more processors, based on the measure of relative negotiability of the one or more properties as compared to each other, whether the asking value of a first subset of the one or more properties is more negotiable than the asking value of a second subset of the one or more properties; and generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

The detailed description of the present aspects has been presented for purposes of illustration and description. It is not intended to be exhaustive or to limit the present aspects to the precise forms disclosed. Many modifications and variations are possible in light of the above teachings. Some example aspects were chosen and described in order to best explain the principles of the present disclosure and its practical application, to thereby enable others skilled in the art to best utilize the present aspects and various alternatives with various modifications as are suited to the particular use contemplated.

It will be appreciated by those skilled in the art that various modifications and changes may be made without departing from the scope of the present aspects. All such modifications and changes are intended to fall within the scope of the appended claims.

What is claimed is:

1. A method of machine learning assisted competitiveness analysis of one or more properties available for transfer of ownership, comprising:
receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties;
feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters;
determining, by the one or more processors, based on the measure of relative negotiability of the one or more properties as compared to each other, whether the asking value of a first subset of the one or more properties is more negotiable than the asking value of a second subset of the one or more properties; and
generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

2. The method of claim 1, wherein the measure of relative negotiability of the one or more properties as compared to each other is based on estimated negotiability percentages of the asking value of each of the one or more properties.

3. The method of claim 1, wherein generating the indication comprises providing, on a user interface of the one or more computing devices, responsive to the asking value of the first subset of the one or more properties being more negotiable than the asking value of the second subset of the one or more properties, a graphical representation of the first measure of relative negotiability of the one or more properties, wherein the graphical representation is configured to indicate that the asking value of the first subset of the one or more properties is more negotiable than the asking value of the second subset of the one or more properties.

4. The method of claim 3, wherein the graphical representation comprises a heat map configured to indicate that the asking value of the first subset of the one or more properties is more negotiable than the asking value of the second subset of the one or more properties.

5. The method of claim 1, wherein generating the indication comprises sending, by the one or more computing devices, responsive to the asking value of the first subset of the one or more properties being more negotiable than the asking value of the second subset of the one or more properties, a message configured to indicate that the asking value of the first subset of the one or more properties is more negotiable than the asking value of the second subset of the one or more properties.

6. The method of claim 1, wherein sending the message comprises pushing the message into a user device of a user and/or sending the message to an email address of the user.

7. The method of claim 1, wherein the one or more properties comprise one or more real estate properties, wherein the first data comprises at least: the asking value for the transfer of ownership of each of the one or more real estate properties, the one or more first parameters indicative of the assessed value of each of the one or more real estate properties, and one or more second parameters indicative of the measure of similarity among the one or more properties including at least a geographical location of each of the one or more real estate properties.

8. The method of claim 7, wherein, for each real estate property, the first data further comprises a quantity of other similar real estate properties that are available, an amount of time that real estate property and/or similar real estate properties have been available, an average amount of time in a recent period that similar transferred real estate properties have remained available before being transferred, if and/or when and/or how much and/or how many times the asking value of that real estate property has been adjusted, past and/or current and/or future market sentiment of potential parties interested in acquiring that real estate property, past and/or current and/or future rental market value of that real estate property and/or other similar real estate properties.

9. The method of claim 1, wherein the one or more properties comprise one or more vehicles, wherein the first data comprises at least: the asking value for the transfer of ownership of each of the one or more vehicles, the one or more first parameters indicative of the assessed value of each of the one or more vehicles based at least on their MSRP, and the one or more second parameters indicative of the measure of similarity among the one or more vehicles including model, year, mileage, color, and transmission type of the one or more vehicles.

10. The method of claim 1, wherein the first data comprises textual or audio data associated with the one or more properties, wherein the at least one trained machine learning model comprises a natural language processing model trained to generate the measure of relative negotiability of the asking value of the one or more properties as compared to each other at least based on analyzing the textual or audio data.

11. The method of claim 1, further comprising:
receiving, by the one or more processors of the one or more computing devices, updated data comprising an update to the first data;
feeding, by the one or more processors of the one or more computing devices, the updated data into the at least one trained machine learning model to generate an updated measure of relative negotiability of the asking value of the one or more properties as compared to each other;
determining, by the one or more processors of the one or more computing devices, based on the updated measure of relative negotiability of the asking value of the one or more properties as compared to each other, whether the asking value of a third subset of the one or more properties is more negotiable than the asking value of a fourth subset of the one or more properties; and
generating, by the one or more computing devices, responsive to the asking value of the third subset of the one or more properties being more negotiable than the asking value of the fourth subset of the one or more properties, a second indication configured to indicate that the asking value of the third subset of the one or more properties is more negotiable than the asking value of the fourth subset of the one or more properties.

12. The method of claim 1, further comprising:
receiving second data associated with a recent transfer of ownership of a property; and
updating the at least one trained machine learning model based on the second data.

13. The method of claim 12, further comprising, responsive to updating the at least one trained machine learning model:
feeding, by the one or more processors of the one or more computing devices, the first data and the second data into the at least one trained machine learning model to generate an updated measure of relative negotiability of the asking value of the one or more properties as compared to each other;
determining, by the one or more processors of the one or more computing devices, based on the updated measure of relative negotiability of the asking value of the one or more properties as compared to each other, whether the asking value of a third subset of the one or more properties is more negotiable than the asking value of a fourth subset of the one or more properties; and
generating, by the one or more computing devices, responsive to the asking value of the third subset of the one or more properties being more negotiable than the asking value of the fourth subset of the one or more properties, a second indication configured to indicate that the asking value of the third subset of the one or more properties is more negotiable than the asking value of the fourth subset of the one or more properties.

14. The method of claim 1, wherein the at least one trained machine learning model implements an ensemble of machine learning models including a meta model that aggregates outputs of a plurality of machine learning models.

15. The method of claim 14, wherein the plurality of machine learning models comprises a regression model trained to analyze conventional property features in the first data.

16. The method of claim 14, wherein the plurality of machine learning models comprises a convolutional neural network trained to analyze sequential data in the first data.

17. The method of claim 14, wherein the plurality of machine learning models comprises a recurrent neural network trained to analyze temporal trends in the first data.

18. The method of claim 14, wherein the plurality of machine learning models comprises a natural language processing model trained to analyze textual or audio features in the first data.

19. A system comprising:
one or more memories storing instructions, individually or in combination; and
one or more processors configured, individually or in combination, to execute the instructions to perform a method of machine learning assisted competitiveness analysis of one or more properties available for transfer of ownership, including:
receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties;
feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters;
determining, by the one or more processors, based on the measure of relative negotiability of the one or more properties as compared to each other, whether the asking value of a first subset of the one or more properties is more negotiable than the asking value of a second subset of the one or more properties; and
generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.

20. One or more non-transitory computer-readable media storing instructions individually or in combination, wherein the instructions are executable by one or more processors, individually or in combination, to perform a method of machine learning assisted competitiveness analysis of one or more properties available for transfer of ownership, including:
receiving, by one or more processors of one or more computing devices, first data associated with the one or more properties, the first data comprising at least: an asking value for the transfer of ownership of each of the one or more properties, one or more first parameters indicative of an assessed value of each of the one or more properties, and one or more second parameters indicative of a measure of similarity among the one or more properties;
feeding, by the one or more processors, the first data into at least one trained machine learning model to generate a measure of relative negotiability of the asking value of the one or more properties as compared to each other, wherein, for each property, the at least one trained machine learning model is trained to output a respective measure of relative negotiability of a respective asking value of that property and an associated confidence score based on at least: a difference between the respective asking value of that property and a respective assessed value of that property as indicated by the one or more first parameters, and a quantity of other properties that are similar to that property as indicated by the one or more second parameters;
determining, by the one or more processors, based on the measure of relative negotiability of the one or more properties as compared to each other, whether the asking value of a first subset of the one or more properties is more negotiable than the asking value of a second subset of the one or more properties; and
generating, by the one or more processors, responsive to the asking value of the first subset of the one or more properties being more negotiable than the asking value of the second subset of the one or more properties, an indication configured to indicate that the asking value of the first subset of the one or more properties is more negotiable than the asking value of the second subset of the one or more properties.
